(19) United States
(12) Patent Application Publication
(10) Pub. No.: US 2003/0034966 A1
(43) Pub. Date: Feb. 20, 2003

(54) Dual voltage power supply apparatus

(75) Inventor: Jaenam Kim, Incheon (KR)

Correspondence Address: FITCH EVEN TABIN AND FLANNERY, 120 SOUTH LA SALLE STREET, SUITE 1600, CHICAGO, IL, 60603-3406, US

(73) Assignee: Jaenam Kim, Namdong-gu (KR)

(21) Appl. No.: 10/207,391

(22) Filed: Jul. 30, 2002

(30) Foreign Application Priority Data
Jul. 31, 2001 (KR) 2001-46363

(51) Int. Cl. G09G 5/00

(52) U.S. Cl. 345/211

(57) ABSTRACT

A dual voltage power apparatus comprises a dual voltage power supply portion for forward-biasing a positive voltage and/or reverse-biasing a negative voltage into a load including a plurality of paired or grouped LEDs; and a multi-color LED driver for controlling the operating of the dual voltage power supply apparatus to supply the positive and/or negative voltages to the load, which is constructed as a single module, in which a plurality of modules facilitate the construction of an image display system to represent various images or motion pictures.

### BACKGROUND OF THE INVENTION

The invention is related to a multi-color LED (Light Emitting Diode) drive apparatus for providing dual power voltages having positive and negative polarities, and particularly, to a dual voltage power supply apparatus including a LED driver and a dual power supply portion for controlling the driving of a plurality of LEDs of a string type which connects LEDs connected in parallel to one another and an image display system which arranges a plurality of dual color LEDs connected in parallel to one another on a printed circuit board or an electric board, properly.

### PRIOR ART

In general, LEDs are broadly used as separated elements or grouped elements in an image display system such as an electric board in order to represent motion pictures or fixed image. The image display system is provided with a brightness modulation apparatus to determine the brightness level of a LED. The brightness modulation apparatus can use a linear fixed pulse width modulation method in order to obtain a proper brightness corresponding to a driving value (brightness level) inputted as image information thereinto, but it has a limited modulation range due to the restriction of a driving frequency. It causes the limitation of the distinction and resolution in the image display system.

In order to overcome these problems, an image display system provided with a non-linear high step image driving apparatus is disclosed in Korean Publication No. 260196 issued on Mar. 9, 1998, which adapts a non-linear variable pulse width modulation method. The image display system receives an input image signal having a predetermined brightness driving information as digital value, converts the information signal into a non-linear variable pulse width modulation signal and supplies the modulation pulse signal to a LED driver in order to drive a LED at a brightness level corresponding thereto, so that the image is represented in a high distinctness and resolution state on a display.

On the other hand, even through the brightness control of a plurality of LEDS is feasible, it is natural that the driving current of LEDs should be adjusted in an optimum state. Namely, a LED driver is supposed to determine the performance of the image display system based on how to apply the driving current to the LEDs. Thus, a technology of improving the performance of the LED driver has encountered a very important issue.

Nevertheless, the LED driver has been constructed using a plurality of bipolar transistor buffers and current limiting resistors. A typical multi-LED driver will be explained referring to FIG. 1.

The LED driver includes a plurality of terminals, in which a terminal X₀ is connected through a resistor to a transistor Tr₀, the emitter of which is connected to a power terminal Vcc, and terminals X₁ to Xn are respectively connected through a resistor in order to each of transistors Tr₁ to Trn. The transistors Tr₁ to Trn are respectively connected to each of lighting emitting diodes LED, to LEDn, which are connected in common to the emitter of the transistor Tr₀. It is known that the cathodes of the LEDs function as a control terminal and the anodes function as a common terminal, while the driving source of the light emitting diode is configured as a single power source. But, the LED driver requires n+1 transistors to operate the light emitting diodes LED₁ to LEDn and separate n+1 switches to operate the transistors Tr₁ to Trn. For example, four lead lines including two lighting control lines, one power source line and one switching control line are required to light two light emitting diodes. Thus, it has a disadvantage in that a plurality of lines are required corresponding to the number of the light emitting diode.

An improved technology of driving a plurality of light emitting diodes is disclosed in U.S. Pat. No. 5,966,110 issued on Nov. 26, 1996 to Mr. Klaas Van Zalinge, which is entitled “a LED driver”. If the LED driver is represented as an equivalent circuit, it has first terminals connected to a common output stage and second terminals respectively receiving different, suitably rectified, phases of a sinusoidal signal in order to light a plurality of a pair of diodes. Namely, as shown in FIG. 2, the LED driver has three lead lines including a ground line and paired lines W3 and W4 of switches SW3 and SW4 that are respectively connected though resistor R to a power source line of 5V corresponding to a single power supply. The ground line is connected in common to the coupled terminal of a plurality of LED groups DL₁ to DLn, and the paired lines are connected through each of switches SW3 and SW4 to other terminals of a plurality of LED groups DL₁ to DLn. Each of a plurality of LED groups is constituted as a single unit of a pair of LEDS coupled in parallel to each other. It has a feature in that the LED driver uses a single power supply and has two control lines. Therefore, one LEDs of a plurality of LED groups DL₁ to DLn connected to the line W3 are driven upon the turning-on of the switch SW3, and on the contrary, the other LEDs of a plurality of-LED groups DL₁ to DLn connected to the line W4 are driven upon the turning-on of the switch SW4. Herein, the LED group can be paired as different color LEDs, so that the color LEDs are separately lighted or simultaneously lighted to mix different colors with each other, thereby displaying the effective color image.

But, the LED driver has a disadvantage in that if paired LED groups are connected directly to lead wires without mounting parallel paired LEDs on a printed circuit board therewith, three lead wires are required with numerous connecting points.

Therefore, it is known that it is very preferable if the mounting of a plurality of paired or grouped LEDs on the printed circuit board is easy, the number of a lead wire is minimized and the driving control of grouped LEDs is easy.

In order to resolve these problems and disadvantages, the object of the invention is to provide a dual voltage power supply apparatus including a LED driver and a dual power supply portion for controlling the driving of a plurality of LEDs of a string type which connects LEDs paired or grouped in parallel to one another.

Another object of the invention is to provide a dual voltage power supply apparatus including a LED driver and a dual power supply portion for controlling the driving of an image display system which arranges a plurality of dual color LEDs connected in parallel to one another on a printed circuit board or an electric board.

Another object of the invention is to provide a dual voltage power supply apparatus including a LED driver and a dual power supply portion for controlling the driving of a plurality of LEDs that are connected at the same time in parallel to two lead wires for dual power voltages.

### SUMMARY OF THE INVENTION

According to the invention, a dual voltage power apparatus comprises a dual voltage power supply portion for forward-biasing a positive voltage and/or reverse-biasing a negative voltage into a load including a plurality of paired or grouped LEDs; and a multi-color LED driver for controlling the operating of the dual voltage power supply apparatus to supply the positive and/or negative voltages to the load.

The dual voltage power apparatus including at least two dual voltage power supply portions corresponding to the multi-color LED driver is constructed as a module to form an image display system.

### BRIEF DESCRIPTION OF THE DRAWINGS

The invention now will be described in detail with respect to the accompanying drawings, in which:

FIG. 1 is a circuit illustrating a conventional driver with a single power terminal for driving a plurality of LEDs;

FIG. 2 is an equivalent circuit illustrating another conventional driver with single power supply apparatus for driving a plurality of LEDs;

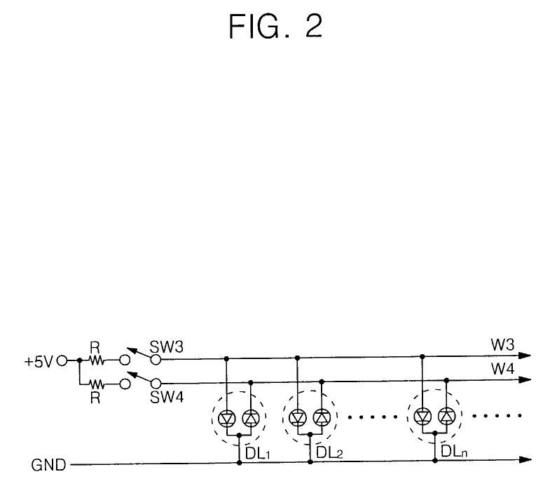

FIG. 3 is a circuit illustrating a dual voltage power supply apparatus provided with a multi-color LED driver according to one embodiment of the invention;

FIG. 4 is a circuit illustrating the connection of a plurality of a pair of LEDs arranged in parallel to one another to a dual voltage power supply apparatus;

FIG. 5 is a circuit illustrating a dual voltage power supply apparatus according to another embodiment of the invention;

FIG. 6 is a circuit illustrating a dual voltage power supply apparatus according to another embodiment of the invention;

FIGS. 7A and 7B are a circuit illustrating a switching portion of each of multi-color drivers of FIGS. 5 and 6;

FIG. 8 is a block diagram illustrating a principle that a microprocessor portion controls a plurality of dual voltage power supply apparatuses configured in a predetermined arrangement.

### DETAILED DESCRIPTION OF THE INVENTION

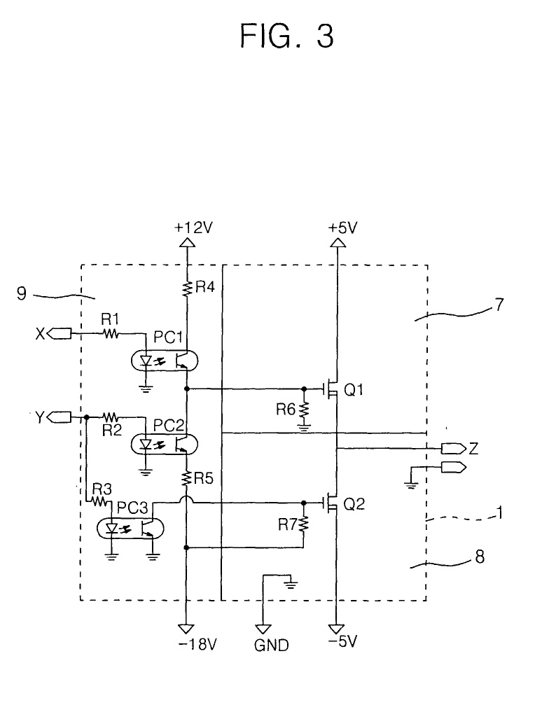

FIG. 3 is a circuit showing a dual voltage power supply apparatus provided with a multi-color LED driver. The dual voltage power supply apparatus 1 comprises a dual voltage source portion including positive and negative voltage power source portions 7 and 8 for supplying dual voltages +5V and −5V to a load, selectively, and a multi-color LED driver for controlling the positive and negative voltage source portions to output its corresponding voltage.

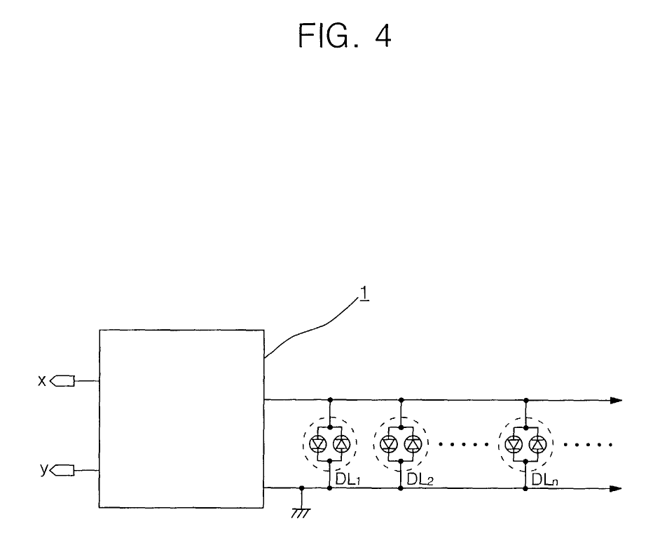

FIG. 4 shows a load connected to the dual voltage power supply apparatus 1. The load comprises a plurality of LEDs connected in parallel to each another or a plurality of a pair of LEDs connected in parallel to each another.

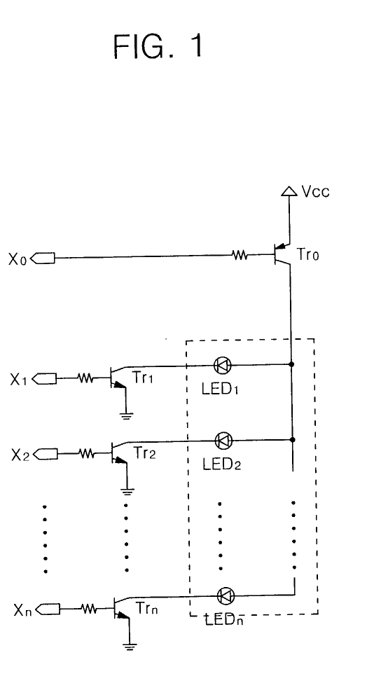

In the dual voltage portion, the positive voltage source portion 7 includes an N-channel effective field transistor Q1 for forward-biasing a positive voltage +5V applied to one power supply terminal and an N-channel effective field transistor Q2 for reverse-biasing a negative voltage 15V applied to the other power supply terminal. The positive and negative voltage source portions 7 and 8 are driven under the control of the multi-color LED driver 9. The multi-color LED driver 9 has control terminals X and Y for receiving control signals from a LED driving control system (not shown) such as a non-linear variable pulse modulation device as described in FIG. 1. The control terminal X is connected through a resistor R1 to a photo coupler PC1, and the control terminal Y is connected through resistors R2 and R3 to each of photo couplers PC2 and PC3. The photo coupler PC1 has a light-receiving transistor, the emitter of which is connected through a resistor R6 to the field-effect transistor Q1 and to the light-receiving transistor of the photo coupler PC2. The photo coupler PC2 is connected at the emitter through a resistor R5 to a control power source terminal of −18V and through a resistor R7 to the gate of the field-effect transistor Q2. The photo coupler PC3 is connected at the collector of its light-receiving transistor to the gate of the field effect transistor Q2.

The dual voltage power supply apparatus 4 as described above is connected to the load Z including a plurality of LED groups DL₁ to DLn, in which one LED of the LED group is forward-biased and other LED is reverse-biased on two lead wires.

The operating of the dual voltage power supply apparatus 1 will be explained below: when a high level of +5V is applied to the control terminal X, the control signal is applied through the resistor R1 to the photo coupler PC1 to be turned on. A positive voltage of +12V at a positive voltage terminal is divided by resistance values of resistor R4 and R6. The divided voltage is applied to the gate of the filed-effect transistor Q1. At this time, the field-effect transistor Q1 is turned on to apply the voltage +5V of the positive voltage source terminal to the load Z connected to its source.

On the other hand, when a control signal of a low level is applied to the control terminal X and a control signal of a high level is applied to the control terminal Y, the photo coupler PC1 is turned off, and other photo couplers PC2 and PC3 are turned on. At this time, the field-effect transistor Q1 is turned off, and the field-effect transistor Q2 is turned on with a gate potential of −18V lower than a source potential being turned into a potential of OV, so that a voltage −5V of a voltage source terminal is applied to the load Z. Namely, if the high level signal is applied to the control terminal Y, the photo coupler PC1 is turned on. At this time, the gate potential of the field-effect transistor Q1 is turned into a potential value of about −16.3V divided by the resistors R5 and R6 that is lower than the source potential thereof, so that the field-effect transistor Q1 is turned off. Herein, it is noted that even though the high level potential is applied to the control terminal X, the gate potential of the field-effect transistor Q1 should be lower than the its source potential of −5V. To it, the potential applied to the gate of the field-effect transistor Q2 should be the negative voltage of −18V to be interacted with the control voltage of +12V.

Therefore, the dual voltage power supply apparatus 1 supplies the positive and/or negative voltages to two lead wires related to the load Z to light a plurality of LED groups in a red and/or green color, in which the LED group includes a LED, for example red color, forward-biased and a LED, for example green color, reverse-biased with respect to the voltages of the two lead wires, which are connected in parallel to each another.

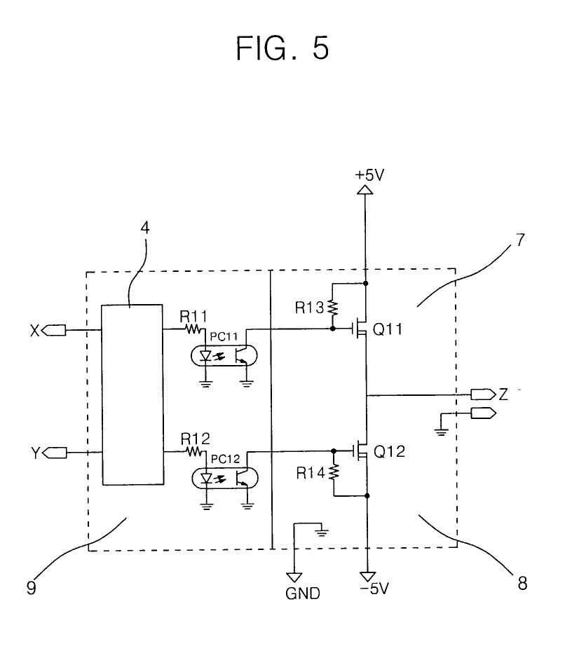

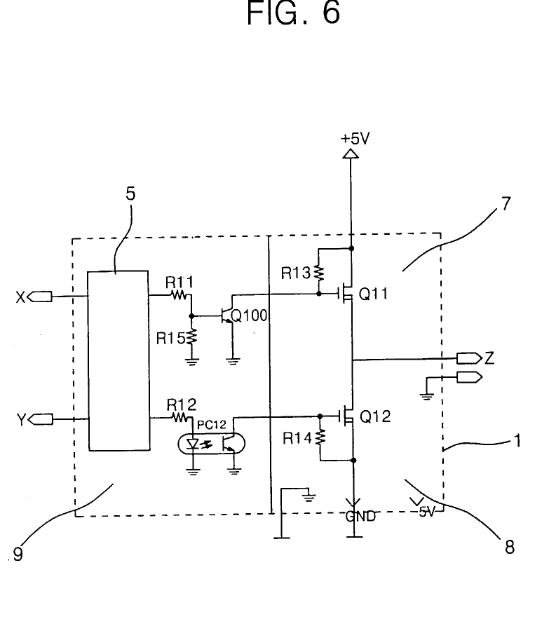

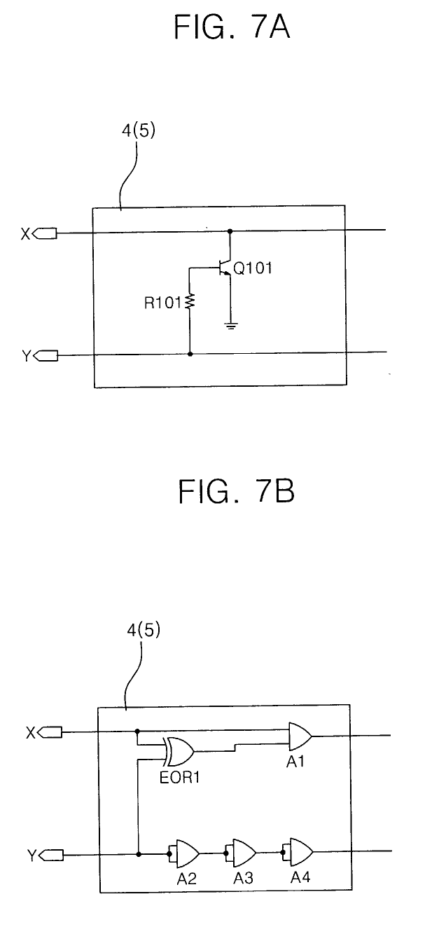

FIGS. 5 and 6 are another embodiment of a dual voltage power supply apparatus as shown in FIG. 4. FIGS. 7A and 7B are a circuit of switching portion 4 and 5 shown in FIGS. 5 and 6.

Control terminal X and Y are connected to switching portion 4 or 5. The switching portion 4 or 6 is connected through resistors R11 and R12 to each of photo couplers PC11 and PC12. The photo couplers PC11 and PC12 each is connected to a P-channel field-effect transistor Q11 and a N-channel field-effect transistor Q12. A load Z is connected to a point between the P-channel field-effect transistor Q11 and the N-channel field-effect transistor Q12. Herein, it is noted in FIG. 6 that the switching portion 5 is connected to a transistor Q100 instead of the photo coupler PC11. Also, positive and negative voltage source portions 7 and 8 are similar to those of the dual voltage power supply apparatus in FIG. 3, but what the negative voltage source portion 8 is grounded at the negative terminal thereof is different from that of FIG. 3.

The switching portion 4(5) comprises a transistor Q101 connected through a resistor R101 as shown in FIG. 7A. As shown in FIG. 7B, the switching portion 4(5) comprises a logic circuit. A control terminal is connected to one terminals of an exclusive OR gate EOR1 and AND gate A1 at the same time. A control terminal Y is connected to the other terminal of the exclusive OR gate EOR1 and an AND gate A2. The exclusive OR gate EOR1 is connected at the output terminal to the AND gate A1, and the AND gate A2 is connected in order to AND gates A3 and A4.

The dual voltage power supply apparatus 1 described above is operated as follow: referring to FIG. 5, a control signal of a high level of +5V applied to the control terminal X turns on the photo coupler PC11 passing through the switching portion 4 and the resistor R11. The field-effect transistor Q11 is also turned on to apply a positive voltage of +5V from its source to the load Z.

When each of the control terminals X and Y is at a low level state (0V) and a high level, the photo coupler PC11 is turned off. At the same time, the other photo coupler PC12 and the transistor Q101 of the switching portion 4 are turned on. Namely, the high-level control signal turns on the photo coupler PC2 passing through the switching portion 4 and the resistor R12. And, the other field-effect transistor Q12 is turned on to apply a negative voltage of −5V to the load Z under, the state that the field-effect transistor Q11 is turned off.

As described above, when the control terminal Y is at the high level state, the transistor Q101 of the switching portion 4 is turned on, but the field-effect transistor Q11 is kept at the off state. Thereafter, the operating of the load Z is similar to that of the embodiment of FIG. 4, the detailed explanation of which is omitted.

Referring to FIG. 6, when the control terminal X is at the high level of +5V, the control signal turns on the transistor Q100 passing through the switching portion 5 and the resistor R11. The field-effect transistor Q11 is turned on to apply the positive voltage of +5V from the source thereof to the load Z.

When each of the control terminals X and Y is at a low level state (0V) and a high level, the photo coupler PC12 is turned on. Namely, the high-level control signal turns on the photo coupler PC2 passing through the AND gates A2 to A4 of the switching portion 4 and the resistor R12. At the same time, the other field-effect transistor Q12 is turned to apply a negative voltage of −5V to the load Z under the state that the field-effect transistor Q11 is turned off.

As described above, when the control terminal Y is at the high level state, the control signal is turned into the low level through the exclusive OR gate EOR1 and the AND gate A1, and the field-effect transistor Q11 is kept at the off state. Thereafter, the operating of the load Z is similar to that of the embodiment of FIG. 4, the detailed explanation of which is omitted.

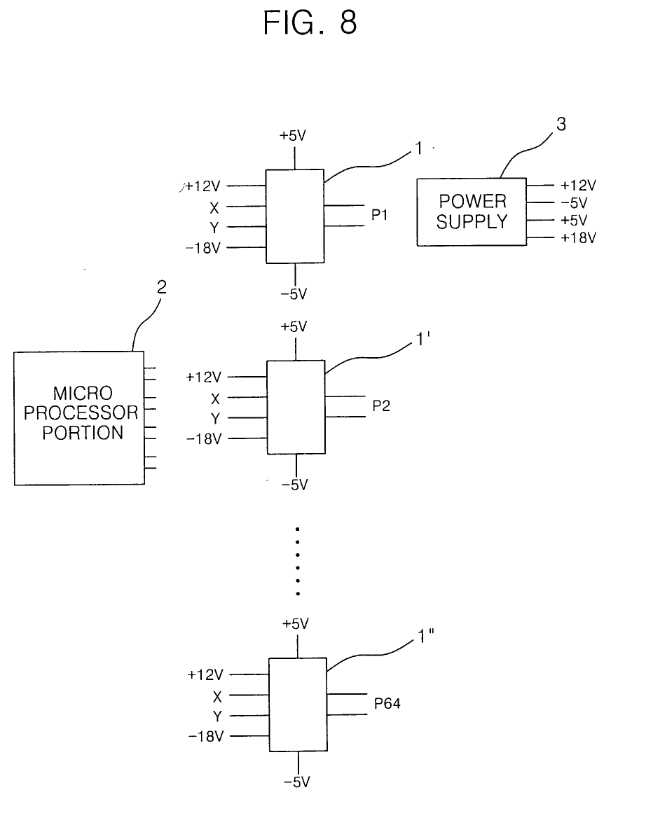

FIG. 8 is a block diagram showing the configuration of a display system using a plurality of dual voltage power supply apparatuses according to the invention. A plurality of the dual voltage power supply apparatuses 1 provided with the multi-color LED driver 2 are arranged in a predetermined pattern to form a display system such as an electric board, etc., which is controlled by a microprocessor portion 2. The microprocessor portion 2 outputs a plurality of control signals to the control terminals X and Y of a plurality of the dual voltage power supply apparatuses 1, 1′, 1′=. A power supply portion 3 is a switching mode power supply device which outputs voltages of +12V, +5V, −18V, −5V, etc. to the dual voltage power supply apparatuses 1, 1′, 1′=. The dual voltage power supply apparatuses 1, 1′, 1′=apply the positive and/or negative voltages at their outputting terminals P1 to P64 to the two lead wires related to the load Z, thereby lighting the LED groups in red and green colors.

Therefore, the microprocessor portion 2 selectively outputs the control signals of the positive and/or negative voltages to the dual voltage power supplies 1, 1′, 1′=to be controlled, selectively, so that the electric board or other image display system displays predetermined various images and/or motion pictures.

As described above, the invention is adapted to an image display system that can be accomplished by a plurality of dual voltage power supply apparatuses, in which the dual voltage power supply apparatus comprises a multi-color LED driver and a dual voltage power supply portion including positive and negative power source portions to have two lead wires as an outputting terminal related to a load, the dual voltage power supply apparatus is designed to be constructed as one module, so that a plurality of modules facilitate the construction of an image display system to represent various images or motion pictures.

What is claimed is:

1. A dual voltage power supply apparatus comprising:
a dual voltage power supply portion for forward-biasing a positive voltage and/or reverse-biasing a negative voltage into a load including a plurality of paired or grouped LEDs; and,
a multi-color LED driver for controlling the operating of the dual voltage power supply portion to supply positive and/or negative voltages to the load.

2. The dual voltage power supply apparatus as claimed in claim 1, in which:
the dual voltage power supply portion comprises a positive voltage source portion and a negative voltage source portion, in which the positive voltage source includes a N-channel field-effect transistor connected to a positive voltage terminal to forward-bias a positive voltage and the negative voltage source includes a N-channel field-effect transistor connected to a negative voltage terminal to negative-bias a negative voltage.

3. The dual voltage power supply apparatus as claimed in claim 1 or claim 2, in which:
the multi-color LED driver comprises a photo coupler having one control terminal and a positive voltage terminal, which is connected to the forward-biasing field-effect transistor; other photo coupler having the other control terminal and a negative control voltage terminal; and the other photo coupler having the other control terminal, which is connected to the gate of the other field-effect transistor.

4. The dual voltage power supply apparatus as claimed in claim 2 or claim 3, in which:
the multi-color LED driver comprises a switching portion connected to the control terminal to output their control signals and photo-couplers turned on by the outputting signals to apply the positive and negative voltages to the corresponding field-effect transistor.

5. The dual voltage power supply apparatus as claimed in claim 2 or claim 3, in which:
the multi-color LED driver comprises a switching portion connected to the control terminal to output their control signals and a transistor and a photo-coupler turned on by the outputting signals to apply the positive and negative voltages to the corresponding field-effect transistor.

6. The dual voltage power supply apparatus as claimed in claim 4 or claim 5, in which:
the switching portion includes a transistor connected between the two control terminals.

7. The dual voltage power supply apparatus as claimed in claim 4 or claim 5, in which:
the switching portion includes a logic circuit having one control terminal connected to an exclusive OR gate and other control terminal connected in order to three AND gates.

8. The dual voltage power supply apparatus as claimed in any one of preceding claim s, in which:
the dual voltage power supply apparatus is constructed as one module to form an image display system.
